(19) United States
(12) Patent Application Publication
(10) Pub. No.: US 2013/0230374 A1
(43) Pub. Date: Sep. 5, 2013

(54) Truck bed lift

(71) Applicant: Douglas John Kerkvliet, Custer, SD (US)

(72) Inventor: Douglas John Kerkvliet, Custer, SD (US)

(21) Appl. No.: 13/385,713

(22) Filed: Mar. 2, 2012

(51) Int. Cl. B60P 1/34

(52) U.S. Cl. 414/477

(57) ABSTRACT

A truck bed lift is disclosed which may be used to lift loads either into or out of the bed of a truck.

### BACKGROUND OF THE INVENTION

1. Field of the Invention

The present invention relates generally to hoists and more specifically to a lift which may be used to lift objects into the bed of a truck.

2. Background Information

For many years people have struggled with lifting heavy objects into the bed of a truck such as a pickup. The height of a pickup bed varies somewhat, but it is usually in the neighborhood of about three feet. Lifting a heavy object or a palette of, for example, concrete blocks the three feet from the ground to the pickup bed can be very difficult or impossible unless some effective assisting means is employed. Various lifts have been invented and used to assist in lifting objects onto a truck bed.

Some such lifts are affixed to the rear end of the bed and employ hydraulics to move the lift up and down. In other cases a small hoist or crane is affixed to the pickup bed and may be used to lift heavy objects onto the bed. Problems often arise when using a conventional hoist. The object must be adjusted or manipulated to insure that it is lifted in a manner which prevents damage to the truck or the load caused by the object and the truck coming into violent contact with each other. In other instances the shape or composition of the object or objects to be loaded makes it difficult to attach the hoist to the load.

The truck bed lift of the instant invention solves the above problems by providing a truck mounted lift which includes a hoist which is capable of being temporarily affixed to a load platform and of lifting and pulling the platform onto or off of the bed of the truck. The ideal invention should also provide for insuring that the load moves smoothly from the ground to the bed without causing damage to either to object or the truck. It should also be simple, reliable, inexpensive, and easy to operate and maintain.

### SUMMARY OF THE INVENTION

The truck bed lift of the instant invention includes a hoist portion which is removably affixed to the truck bed. The hoist includes a hook which is affixed to a frame. The frame is rotatably affixed to the hoist and may be moved forward and rearward using hydraulic pistons. A separate platform is provided. The platform includes a hook pin which may be engaged by the hook.

The platform is placed on the ground to the rear of the truck bed and the hook is manipulated using the hydraulics until it moves rearward from the truck bed and engages the hook pin on the platform. The objects to be loaded onto the bed are then placed on the platform. The hydraulics are then used to move the hook upward and rearward. The hook lifts and pulls the platform up onto the bed of the pickup. Guide rollers are provided such that the platform moves smoothly into the bed to prevent damage to the pickup or the load.

The load may then be transported to an appropriate location. The object or objects to be unloaded may travel on the platform. The platform may then be unloaded by reversing the loading process. That is, the hook is manipulated until the platform has been moved rearward and downward and it deposited on the ground.

One of the major objects of the present invention is to provide a truck mounted lift which includes a hoist which is capable of being temporarily affixed to a load platform and of lifting and pulling the platform onto or off of the bed of the truck.

Another objective of the present invention is to insure that the load moves smoothly from the ground to the bed without causing damage to either to object or the truck.

Another objective of the present invention is to provide a truck bed lift which is simple, reliable, inexpensive, and easy to use and maintain.

These and other features of the invention will become apparent when taken in consideration with the following detailed description and the drawings.

### BRIEF DESCRIPTION OF THE DRAWINGS

FIG. 1 is a side view of the hoist portion of the instant invention;

FIG. 2 is a side view of the platform portion of the instant invention;

FIG. 3 is a sectional view of the hoist portion taken along the line 3-3 of FIG. 1;

FIG. 4 is a sectional view of the platform portion of the instant invention taken along line 4-4 of FIG. 2;

FIG. 5 is a side view of the hoist and platform in operation; and

FIG. 6 is a side view of the hoist and platform with the platform on the ground.

### DESCRIPTION OF A PREFERRED EMBODIMENT

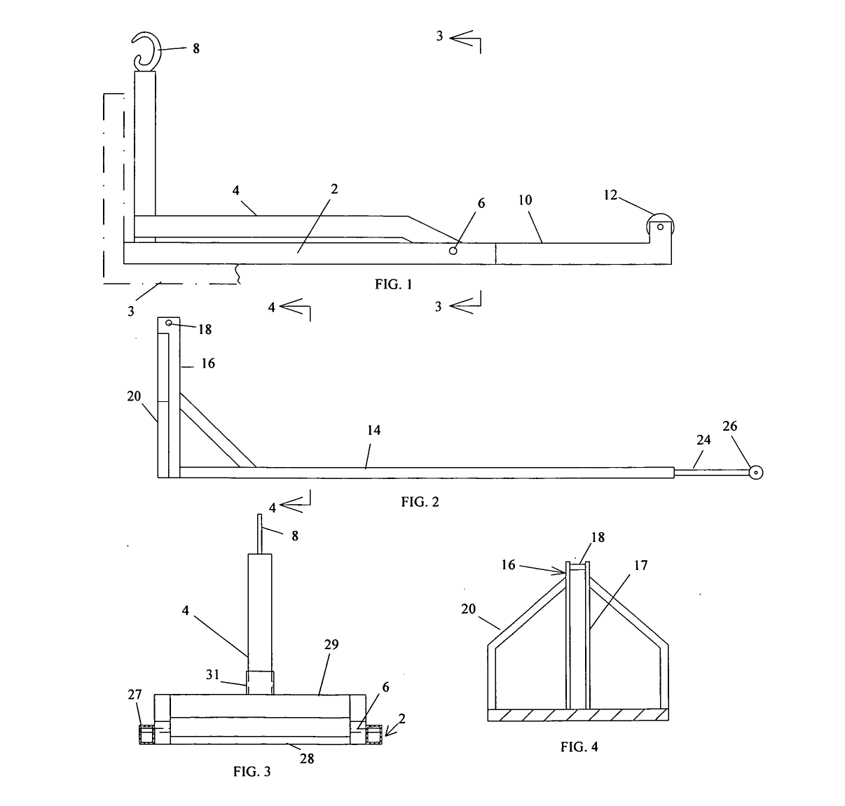

Referring to the drawings, FIGS. 1-6 there are shown a preferred embodiment of the instant invention. Truck bed lift of the instant invention is shown and described as having the hoist portion of the invention being removably affixed to the bed of a pickup, but the invention could be used for other purposes such as lifting loads onto a loading dock. A pickup 3 (not shown in detail) is considered to have a bed in the rear and a cab in the front. The following description will use front and rear or forward and rearward following this convention.

Now referring to FIG. 1, a side view of the hoist portion of the invention is shown. A base 2 is provided which may be affixed to the bed of the pickup 3. A frame 4 is rotatably affixed to the base 2 by means of a base pin 6. (It will be understood that the base pin 6 could be replaced by a hinge.) The frame 4 is generally “L” shaped with the end of the longer leg of the “L” affixed to the base pin 6. This leg is generally horizontal. The shorter leg of the “L” is generally vertical and is located just rearward of the cab of the pickup. A hook 8 is affixed to the end of the shorter leg of the “L” of the frame 4 and opens forward. A strut 10 protrudes rearward from the rearward end of the frame 4 and the rearward end of the strut 10 is located near the end of the pickup bed. A hoist roller 12 is affixed to the rearward end of the strut 10 such that the roller protrudes slightly rearward and upward from the strut 10.

Referring now to FIG. 2, a side view of the platform portion of the invention is shown. A platform base 14 is provided which is slightly smaller than the interior of the bed of the pickup. A pin frame 16 is affixed to the forward end of the platform base 14. The platform base 14 is generally horizontal and the pin frame 16 is generally vertical. A brace 20 is provided between the pin frame 16 and the platform base 14 to provide stability. A platform strut 24 extends rearward from the rearward end of the platform base 14 and a platform roller 26 is affixed to the rearward end of the platform strut 24. A platform pin 18 is affixed to the top portions of said pin frame 16.

Referring now to FIG. 3, a sectional view of the hoist portion of the invention taken along line 3-3 of FIG. 1 is shown. This view better shows the configuration of the various elements. The base 2 has two rails, one on either side of the base. A base strut 28 connects the two rails to provide stability. The base pins 6 (See FIG. 1) rotatably affix the two sides of the frame 4 to the base 2. The vertical portion of the frame 4 is at the forward end of the bed, but in the middle of the bed between the bed sides. As may be seen, this configuration leaves the middle portion of the truck bed open. While the rearward portion of the two sides of said frame 4 are secured by means of said base pins 6, the forward portion is secured to a frame bracket 29 which secures the forward end of said frame 4 and provides a mounting point for the shorter, vertical portion of said frame 4. This view further shows a second embodiment of the instant invention in which the vertical portion of said frame 4 is removably affixed to the frame bracket 29 by means of a collar 31 which is affixed to said frame bracket 29. The vertical portions of said frame 4, is secured within the collar 31 by any conventional means such as set screws.

Referring now to FIG. 4, a sectional view of the platform portion of the invention taken along line 4-4 of FIG. 2 is shown. The pin frame 16 consists of two plates located near the front of the bed, but in the middle of the bed between the bed sides. The platform pin 18 is affixed between the two plates. As may be seen in this view, the brace 20 supports the pin frame 16 in two directions.

Referring now to FIG. 5, a side view of the instant invention in operation is shown. As may be seen, the hook 8 has engaged the platform pin 18. Hydraulic pistons 30 are rotatably affixed to the base 2 and the frame 4 near the forward end of the base 2 and the rearward end of the frame 4. The pistons 30 may be used to move the frame 4 either forward or rearward. The bend toward the rearward portion of the frame 4 is necessary to insure that the frame 4 is properly aligned with the base 2 when the frame 4 is in the down position. As seen in this view, the hook 8 has engaged the platform pin 18. If the pistons 30 are shortened, the hook 8 and the platform base 14 are pulled onto the truck bed. If the pistons 30 are lengthened, the hook 8 and the platform base 14 are pushed rearward such that the platform base 14 may be lowered to the ground. The hoist rollers 12 engage the bottom of the platform base 14 to insure that the platform base 14 moves smoothly into or out of the pickup bed. The platform roller 26 rolls on the ground which also helps to insure that the platform base 14 moves smoothly into or out of the pickup bed.

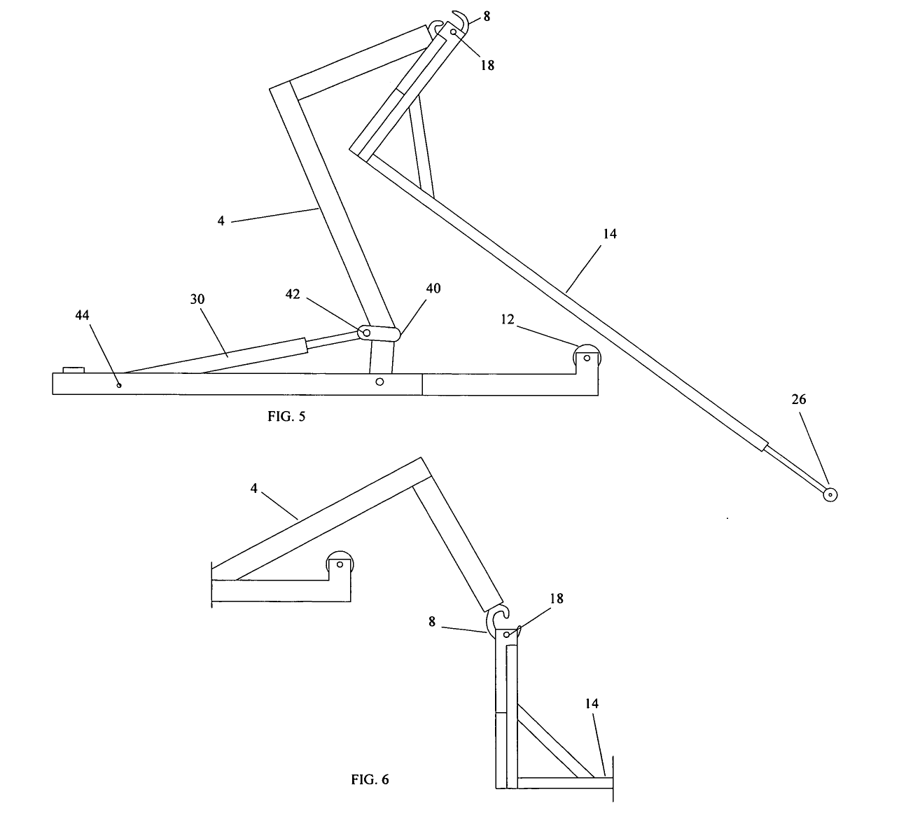

Referring now to FIG. 6, a side view of the instant invention in operation with the platform base 14 on the ground is shown. The frame 4 has been moved rearward sufficiently by the pistons 30 (see FIG. 5) to deposit the platform base 14 on the ground. In this position, the hook 8 may easily engage with or disengage from the platform pin 18.

In operation, the frame 4 is manipulated using the pistons 30 such that the hook 8 engages the platform pin 18. The platform base 14 is on the ground and loaded as desired. The pistons 30 may be used to pull the platform base 14 up onto the pickup bed using the hook 8. The load may then be transported as appropriate. The load may then be unloaded by reversing the process. As may be seen, the frame has an open, wishbone shape. This not only allows for the use of two hydraulic pistons, but is leaves the middle of the pickup bed open. This is particularly important for users who wish to have a fifth wheel hitch ball in the bed of the pickup. The lift of the instant invention may be used without removing such a hitch ball. The hook 8 is removable. This allows the device to lay flat in the pickup bed with not part protruding above the level of the top of the pickup bed. As may also be seen the instant invention works with both short and long box pickups which is an advantage over known devices which require different models for such pickups.

In the preferred embodiment all elements are conventional with structural element being made from steel although other materials having similar properties could be used.

I claim:

1. A truck bed lift for use with a conventional truck which has a forward cab and an open rearward bed, comprising:
(1) a base which is removably affixed in the bed of a truck in which the base is generally rectangular, and located on the bottom of the truck bed, and said base fits around the interior perimeter of the truck bed with the rearward end open;
(2) a frame which fits within said base and is rotatably affixed to said base by a pair of pins located near the rearward end of said frame and near the middle of said base;
(3) said frame having a forward member which is vertical and located near the forward end of the truck bed in the middle of the truck bed, and the forward member having a hook which opens toward the forward end of the truck;
(4) a platform which fits within the bed of the truck and has a horizontal portion and a vertical portion which is at the forward end of the platform, the vertical portion of said platform includes a platform pin which is complementary to and fits within the hook of said frame;
(5) a pair of hydraulic pistons connect the forward and of said base with the rearward end of said frame such that when the hydraulic pistons are extended, said base remains in place and the forward portion of said frame moves upward and rearward; and, when said hydraulic pistons are retracted, said frame moves rearward and downward; and
(6) said hook is capable of engaging the platform pin; and, when said hook is engaged and said hydraulic pistons are extended, said platform is moved rearward and downward until it moves from the bed of the truck to the ground behind the truck and, when said hydraulic pistons are retracted, said platform is move upward and forward until it moves from the ground to the bed of the truck.

2. The truck bed lift of claim 1 in which said frame is rotatably affixed to said base by a pin.

3. The truck bed lift of claim 1 in which said frame is rotatably affixed to said base by a hinge.

4. A truck bed lift for use with a conventional truck which has a forward cab and an open rearward bed, comprising;
(1) a base which fits on the bottom of the truck bed around the inner perimeter of the truck bed in which the base has at least two rails near the sides of said truck bed;
(2) a frame which also fits within said truck bed and which extends to a position just rearward of the cab of said truck and which is capable of being rotatably affixed to the two rails on said base such that the rearward end of the frame rotates about a line between the two rails of said base near the middle of said truck bed;
(3) said frame having a vertical member which is just rearward of the cab of the truck and in the middle of the truck bed and the vertical member having a hook at its top which opens forward;
(4) a platform which fits within the bed of the truck and has a horizontal portion and a vertical portion which is at the forward end of the platform, the vertical portion of said platform includes a platform pin which is complementary to and fits within the hook of said frame;
(5) a pair of hydraulic pistons connect the forward and of said base with the rearward end of said frame such that when the hydraulic pistons are extended, said base remains in place and the forward portion of said frame moves upward and rearward; and, when said hydraulic pistons are retracted, said frame moves rearward and downward; and
(6) said hook is capable of engaging the platform pin; and, when said hook is engaged and said hydraulic pistons are extended, said platform is moved rearward and downward until it moves from the bed of the truck to the ground behind the truck and, when said hydraulic pistons are retracted, said platform is move upward and forward until it moves from the ground to the bed of the truck.

5. The truck bed lift of claim 2 in which said frame is rotatably affixed to said base by a pin.

6. The truck bed lift of claim 2 in which said frame is rotatably affixed to said base by a hinge.
